(19) United States
(12) Patent Application Publication
(10) Pub. No.: US 2009/0056194 A1
(43) Pub. Date: Mar. 5, 2009

(54) Fishing lure

(76) Inventor: Matti Koskinen, Tampere (FI)

Correspondence Address: VENABLE LLP, P.O. BOX 34385, WASHINGTON, DC, 20043-9998, US

(21) Appl. No.: 12/155,253

(22) Filed: May 30, 2008

(30) Foreign Application Priority Data
May 30, 2007 (FI) U20070236

(51) Int. Cl. A01K 85/01

(52) U.S. Cl. 43/42.06

(57) ABSTRACT

A fishing lure comprising
a container for attractant medium; and
a dispenser for dispensing the medium from the container outside the lure.

The dispenser is a reciprocating spray pump arranged to move by the effect of traction of the fishing line. The volume of the container is self-adjusting in accordance with the discharge of the attractant medium.

### FIELD OF INVENTION

The invention relates to a fishing lure to be used in fishing and comprising a container for attractant medium.

### BACKGROUND OF THE INVENTION

It is known to use different kinds of attractants in lures, which dissolve in water from the lure, thus making the lure more attractive to fish. To keep the attractant in the lure for a longer period of time, it can be placed in a container, from which it is gradually released into water by means of a special dispenser. For example the U.S. Pat. No. 6,789,349 discloses a lure containing a medium intended to seep out gradually through a sort of absorbent cord-like “wick”. The function of the lures disclosed in U.S. Pat. Nos. 4,888,907 and 5,321,906 is based on an expanding bladder contained inside the lure, which is filled with attractant up to a pressure, for example by means of a syringe through a fill port, and seepage can be controlled beforehand by tightening the outlet valve to a suitable level. US patent application 2005/0028424 discloses a lure having a mechanism utilizing the flow of water, i.e. the pulling of the lure indirectly, in which a piston moving by the force of water pushes liquid out of a channel through a small opening at the tail of the lure. U.S. Pat. No. 6,779,293 discloses a lure utilizing jerking motion and having a ball at its tail that controls the discharge of liquid from a chamber inside the lure. The air pocket left in the same chamber in connection with filling prevents the seeping of water into the chamber.

The pressure of water surrounding the lure constitutes a problem common to prior art solutions for dispensing liquid from the inside of a lure, as it hampers the function of the lure as soon as it enters deeper waters. Another problem is the fact that the liquid attractant is gradually replaced with water, i.e. it becomes diluted. An air pocket inside the chamber does not prevent this, because when the liquid is gradually discharged, replacement air is not obtained anywhere, i.e. the underpressure produced therein keeps the liquid inside the lure. A piston moving backwards inside the lure is functionally unreliable.

### SUMMARY OF THE INVENTION

The purpose of the invention is to eliminate the aforementioned drawbacks and to introduce a fishing lure in which the dispensing takes place by a mechanically reliable arrangement independent of the fishing action itself, and not requiring pressurizing of the attractant. The dispenser of the attractant is a reciprocating spray pump, arranged to move by the effect of traction of the fishing line, and the volume of the container containing the attractant is self-adjusting in accordance with the discharge of liquid. The spray pump moves back and forth and during its movement it dispenses liquid from inside the container. The pump contains a return spring that produces the return movement of the pump, and a valve, typically a ball, preventing the return flow of liquid. The structure of the pump is simple, and it is known from various sprayer bottles. By means of the pumping movement of the pump, which repeated jerks of the line produce especially in casting, it is possible to force the liquid into the surrounding water irrespective of its pressure, and the liquid contained in the container does not necessarily have to be pressurized. The container from which liquid is dispensed into water becomes smaller in synchronism with the discharge of a liquid through the pump, i.e. replacement air is not required and water is not capable of diluting the liquid.

### BRIEF DESCRIPTION OF THE DRAWINGS

In the following, the invention will be described in more detail with reference to the appended drawing, in which

FIG. 1 shows a general view of the fishing lure in side elevation, and

FIG. 2 shows the dispenser of the fishing lure in its operating position.

### DETAILED DESCRIPTION OF THE INVENTION

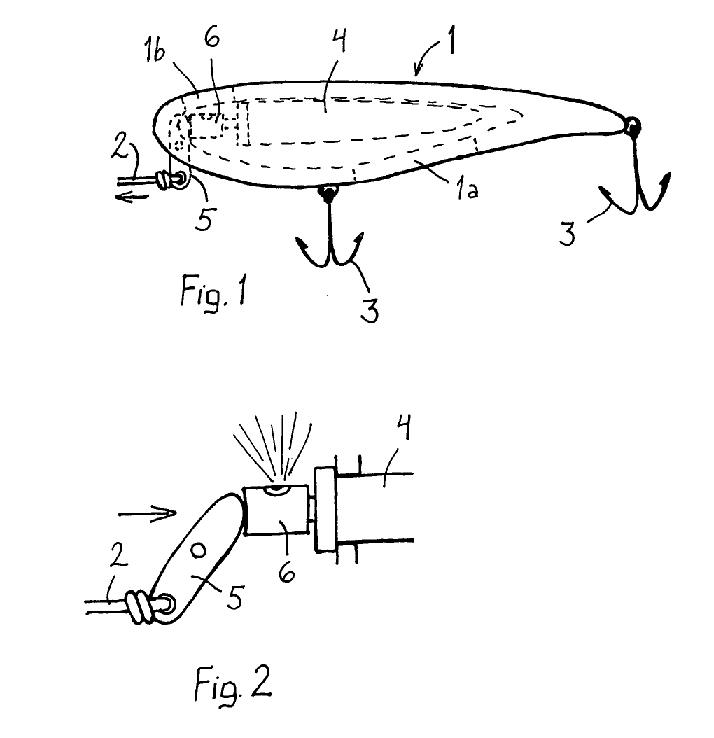

FIG. 1 shows a fishing lure 1 according to the invention in a side view, said lure being fastened to a fishing line 2 by means of which a fisher pulls the lure. In a way known as such the lure also comprises one or several hooks 3.

Inside the lure there is a container 4 for attractant medium in the form of a compressible bag. This gives the advantage that as the medium is gradually drained from the bag, the inner volume of the bag becomes smaller in synchronism therewith, and replacement air or other substance is not required to fill. The lure 1 contains an opening 1a through which the pressure of the surrounding water is also capable of influencing the bag. Different kinds of liquid or flowing attractants for fish, which can be used in this invention, are known as such and will therefore not be described in more detail.

The fishing line 2 is fastened to the lure by means of a lever 5 having in its first end a suitable fastener for the fishing line. The pivot of the lever is fastened to the lure, in the figure to the “head” of the lure, but it can also be located in a diving lip controlling the trolling depth. The second end of the lever is in contact with the plunger part, i.e. piston of the spray pump 6. When the fishing line is jerked, as is customary in casting, the resistance of water makes the lever 5 turn and the plunger part sink by the effect of the second end of the lever, against the force of the return spring. At the same time the liquid is discharged from the spraying orifice contained in the plunger (FIG. 2), because the valve of the pump remains closed. The body of the lure 1 also contains an opening 1b through which the medium is released out into the water. When the effect of the force produced by the jerking motion ceases, the spring of the pump lifts the plunger part to its initial position, while the plunger part is capable of withdrawing liquid from the container again, through the opened valve. By means of the ratio of the moment arms in the lever 5, it is possible to control the pulling force of the fishing line 2 that is sufficient for pressing the pump 6 down.

According to another alternative, the return spring is a extension-spring, wherein the fishing line can be fastened directly to the reciprocating plunger part of the pump 6. Thus, the dispensing discharge takes place when the effect of the force caused by the jerk to of the fishing line 2 ceases, and the extension-spring draws the plunger down. Thus, the extension-spring contains an arrester that prevents the spring from extending too much when a fish bites.

When the container 4 is a deformable compressible bag, the pressure of water is capable of influencing it and the pressure of the liquid in the container already corresponds to the trolling depth. The container 4 may also be rigid, wherein it may comprise a piston that retracts inside the container in synchronism with the discharge of the liquid therefrom.

The container may be located in the fishing lure permanently, and it can be refilled with the attractant. The pump 6 may be detachable from the container 4 and attachable thereto by means of a threaded coupling or quick-release coupling, if the container is refillable. The combination of the container and pump may also be disposable. The container may be arranged to be attached inside the lure so that the pulling or pressing of the pump 6 does not move it (for example in FIG. 2 the collar of the container in front of the opening) and to be detached therefrom. To position the container, the head of the lure may for example be openable. It is also possible that the container itself forms the body of the lure.

It may be considered that the attractant releasing fishing lure includes all devices pulled in water, the purpose of which is to attract fish (trolls, wobblers). It does not necessarily have to resemble the catch, but it may be a separate diving sinker that keeps the actual visual lure within a suitable depth. Moreover, the invention is not limited to any given type of fishing.

1. A fishing lure comprising:
a container for attractant medium; and
a dispenser for dispensing the medium from the container outside the lure;
wherein the dispenser is a reciprocating spray pump, arranged to move by the effect of traction of the fishing line, and the volume of the container is self-adjusting in accordance with the discharge of the attractant medium.

2. The fishing lure according to claim 1, in which the container is a compressible bag.

3. The fishing lure according to claim 2, in which the bag is connected to the pressure of water prevailing around the lure.

4. The fishing lure according to claim 1, in which the spray pump is connected to a lever articulated in the lure and having a fastening point for the fishing line.

5. The fishing lure according to claim 2, in which the spray pump is connected to a lever articulated in the lure and having a fastening point for the fishing line.

6. The fishing lure according to claim 3, in which the spray pump is connected to a lever articulated in the lure and having a fastening point for the fishing line.

7. The fishing lure according to claim 1, in which the spray pump has a fastening point for the fishing line.

8. The fishing lure according to claim 2, in which the spray pump has a fastening point for the fishing line.

9. The fishing lure according to claim 3, in which the spray pump has a fastening point for the fishing line.
